(19) United States
(12) Patent Application Publication
(10) Pub. No.: US 2025/0206921 A1
(43) Pub. Date: Jun. 26, 2025

(54) RESIN COMPOSITION FOR DIE ATTACH FILM WITH EXCELLENT PERFORMANCE WITH LARGE DIE APPLICATIONS

(71) Applicant: Henkel AG & Co. KGaA, Duesseldorf (DE)

(72) Inventors: Jie Bai, Aliso Viejo, CA (US); Phuong U Do, Garden Grove, CA (US); Qizhuo Zhuo, Irvine, CA (US); Daniel M. Kwak, Brea, CA (US); Hwang Kyu Yun, Irvine, CA (US)

(21) Appl. No.: 19/078,469

(22) Filed: Mar. 13, 2025

Related U.S. Application Data
(63) Continuation of application No. PCT/US2023/032978, filed on Sep. 18, 2023.
(60) Provisional application No. 63/407,745, filed on Sep. 19, 2022.

(51) Int. Cl. C08L 9/00; C08K 3/36; C08K 5/315; C08K 5/42

(52) U.S. Cl. CPC C08L 9/00; C08K 3/36; C08K 5/3155; C08K 5/42; C08L 2205/035; C08L 2207/53

(57) ABSTRACT

Aspects of the disclosure relate to compositions for forming films and the use of the films in large die applications. In certain aspects, the disclosure relates to compositions comprising two or more resins, optionally, one or more inorganic fillers, and one or more core shell additives, together with a curative package, to films prepared from the disclosed compositions, and to cured films obtained after cure of the disclosed compositions. In certain aspects, cured films obtained after cure of the disclosed compositions have particular physical properties and/or combinations of physical properties.

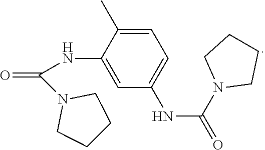 [SMILES: Cc1ccc(NC(=O)N2CCCC2)cc1NC(=O)N1CCCC1]

Aspects of the disclosure relate to compositions for forming films and the use of the films in large die applications. In certain aspects, the disclosure relates to compositions comprising two or more resins, optionally, one or more inorganic fillers, one or more core shell additives, and a curative package, to films prepared from the disclosed compositions, and to cured films obtained after cure of the disclosed compositions. In certain aspects, cured films obtained after cure of the disclosed compositions have particular physical properties and/or combinations of physical properties.

### BACKGROUND

As it looks to the next generation of high performance packages, the materials industry faces the need to improve the high temperature properties of film materials (e.g., die attach film materials). The realization of this goal may bring such benefits as higher thermal stability and, consequently, higher reliability in applications across the automotive, computing, networking, and telecommunication industries. Features that may be associated with improved high temperature properties of film materials include a comparatively high Tg (glass transition temperature), and a comparatively high modulus at a relatively high temperature, such as 200° C.

For reference, FIG. 1 is an example representative of the application of a die attach film to bond silicon die onto metal lead frame surface. In FIG. 1, 1 is molding compound, 2 is wirebond, 3 is silicon die, 4 is die attach film adhesive, 5 is copper leadframe, and 6 is substrate.

Currently, commercial die attach films are used mostly for electronic package assembly with laminate bismaleimide-triazine (“BT”) substrates for memory stacked die applications. Many of these die attach films are based on epoxy or epoxy/acrylate chemistry, and ordinarily do not show high adhesion to metal substrates.

Accordingly, improvements in performance of die attach films on metal substrates and/or large die applications would be desirable.

### SUMMARY

In view of at least the considerations discussed above, there is an interest in compositions comprising two or more resins, optionally, one or more inorganic fillers, and one or more core shell additives, together with a curative package, to films prepared from the compositions, and to cured films obtained after cure of the compositions.

Thus, provided herein are compositions particularly well suited for use in die attach film applications, such as non-conductive die attach film applications. The compositions having advantageous properties making them well suited for use in the automotive industry where high reliability requirements, such as high adhesion to multiple metal lead frame surfaces including copper, silver, and PPF (NiPdAu plated copper lead frame, where Au is the outer-most surface, Ni is the inner-most surface and a Pd layer is sandwiched therebetween), are desirable.

The die attach films made from these compositions demonstrate low stress, which translates to low warpage, which is particularly advantageous for large die applications.

In some embodiments, aspects of the present disclosure are directed to a composition comprising:
(a) two or more resins selected from the group consisting of: (i) at least one of maleimide-containing resins, nadimide-containing resins, or itaconimide-containing resins, and (ii) epoxy resins;
(b) core shell particles comprising a polymeric material having elastomeric or rubbery properties surrounded by a shell comprised of a non-elastomeric polymeric material;
(c) optionally, inorganic fillers;
(d) a curative package comprising

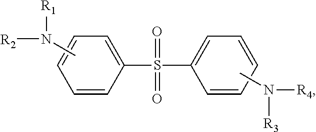

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms,

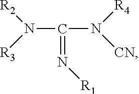

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and

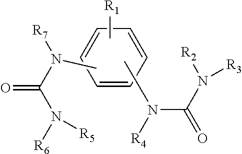

wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms; and
(e) one or more additives selected from the group consisting of adhesion promoters and film formers.

In some aspects, the composition, after B-staged to a film, demonstrates at least the following physical properties:
DSC has an onset temperature of 160° C.˜180° C.,
DSC has a peak temperature of 180° C.˜210° C., and
reaction heat of >30 J/g.

In some aspects, the composition, after B-staged to a film, demonstrates at least the following physical properties when laminated onto 7 mm×7 mm die, after exposure to a temperature of about 175° C. for a period of time of about 1 hour, the die is measured and shows a warpage of less than about 100 um.

In some aspects, the composition, after B-staged to a film, demonstrates at least the following physical properties when laminated onto a metal lead frame or a BT substrate on a 3 mm×3 mm die, after exposure to a temperature of about 175° C. for a period of time of about 4 hours, the film adheres to the metal lead frame showing adhesion of at least 3 kgf per die.

In some aspects, the composition, after B-staged to a film, demonstrates at least the following physical properties:
DMA (Dynamic Mechanical Analysis), which showed a storage modulus at 25° C. of <2,500 MPa, and A glass transition temperature Tg of >200° C.

In some aspects, the composition, after B-staged to a film, demonstrates at least the following physical properties:
DMA (Dynamic Mechanical Analysis), which showed a storage modulus at 100° C. of >50 MPa, and
A glass transition temperature Tg of >200° C.

In some aspects, the composition, after B-staged to a film, demonstrates at least the following physical properties:
DMA (Dynamic Mechanical Analysis), which showed a storage modulus at 150° C. of >20 MPa, and
A glass transition temperature Tg of >200° C.

In some aspects, the composition, after B-staged to a film, demonstrates at least the following physical properties:
DMA (Dynamic Mechanical Analysis), which showed a storage modulus at 200° C. of >10 MPa, and
A glass transition temperature Tg of >200° C.

In some aspects, after application to a metal lead frame and curing at a temperature of 260° C. the composition shows die shear strength of >9 kgf/die on copper metal lead frame and >5 kgf/die on silver metal lead frame.

In some embodiments, aspects of the present disclosure are directed to a curative package comprising

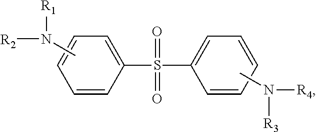

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms,

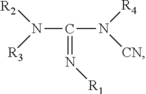

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and

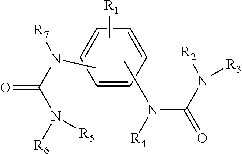

wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms.

### BRIEF DESCRIPTION OF THE DRAWINGS

FIG. 1 presents an example representative of the application of a die attach film to bond silicon die onto metal lead frame surface.

FIG. 2 presents a schematic diagram of a process by which die attach film is used in application.

FIG. 3 presents DMA (dynamic mechanical analysis) data for an exemplary composition of the disclosure (Inventive sample 5 after post cure at 175° C. for 1 hour) in terms of storage modulus (measured in MPa) over an increase in temperature (measured in ° C.), loss modulus (measured in MPa) over an increase in temperature (measured in ° C.), and tan delta (measured in ° C.) over an increase in temperature (measured in ° C.).

FIG. 4 presents DSC (differential scanning calorimetry) data for an exemplary composition of the disclosure (Inventive sample 5) in terms of heat flow (measured in W/g) over an increase in temperature (measured in ° C.).

FIG. 5 presents melt viscosity data for an exemplary composition of the disclosure (Inventive sample 5).

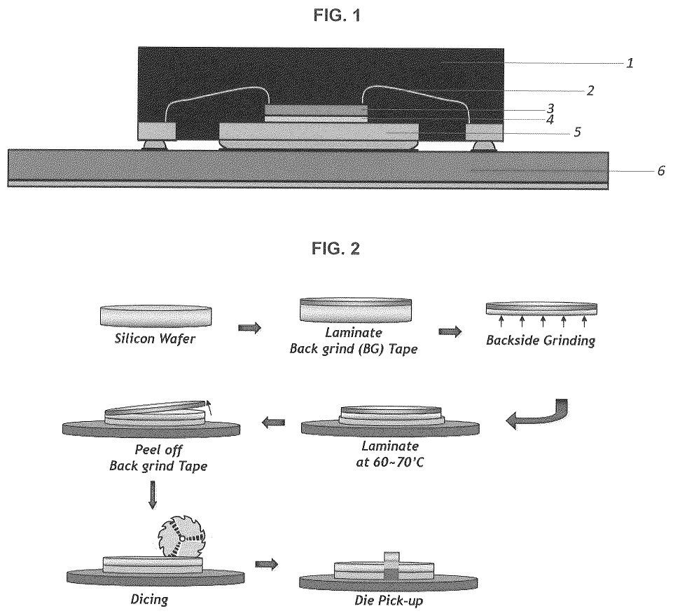

### DETAILED DESCRIPTION

The disclosed compositions and processes may be understood more readily by reference to the following detailed description taken in connection with the accompanying figures, which form a part of this disclosure.

In accordance with the disclosure, there are provided in some embodiments, as noted above, a composition comprising:
(a) two or more resins selected from the group consisting of: (i) at least one of maleimide-containing resins, nadimide-containing resins, or itaconimide-containing resins, and (ii) epoxy resins;
(b) core shell particles comprising a polymeric material having elastomeric or rubbery properties surrounded by a shell comprised of a non-elastomeric polymeric material;
(c) optionally, inorganic fillers;
(d) a curative package comprising

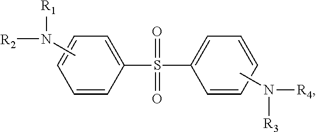

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms,

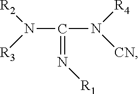

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and

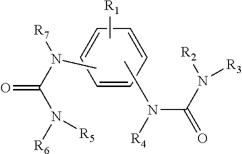

wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms; and
(e) one or more additives selected from the group consisting of adhesion promoters and film formers.

In some embodiments, in connection with the resin component (a)(i), the maleimide-containing resin, nadimide-containing resin, or itaconimide-containing resin is represented by, respectively:

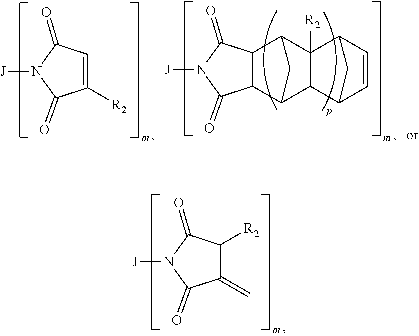

wherein:
m is 1-15,
p is 0-15,
each R² is independently selected from hydrogen or C₁₋₆ alkyl, and
J is a monovalent or a polyvalent radical comprising organic and/or organosiloxane radicals.

In some embodiments, J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
substituted or unsubstituted C₆-C₁₀ aryl;
heterocyclic or substituted heterocyclic species typically having in the range of about 6 up to about 500 carbon atoms,
polysiloxane,
polysiloxane-polyurethane block copolymers, or
combinations of one or more of the above with a linker selected from a covalent bond, —O—, —S—, —NR—, —NR—C(O)—, —NR—C(O)—O—, —NR—C(O)—NR—,
   —S—C(O)—, —S—C(O)—O—, —S—C(O)—NR—, —O—S(O)₂—, —O—S(O)₂—O—,
   —O—S(O)₂—NR—, —O—S(O)—, —O—S(O)—O—, —O—S(O)—NR—, —O—NR—C(O)—,
   O—NR—C(O)—O, —O—NR—C(O)—NR, —NR—O—C(O)—, —NR—O—C(O)—O—,
   —NR—O—C(O)—NR—, —O—NR—C(S)—, —O—NR—C(S)—O—, —O—NR—C(S)—NR—, —NR—O—C(S)—,
   —NR—O—C(S)—O—, —NR—O—C(S)—NR—, —O—C(S)—, —O—C(S)—O—, —O—C(S)—NR—,
   —NR—C(S)—, —NR—C(S)—O—, —NR—C(S)—NR—, —S—S(O)₂—, —S—S(O)₂₋O—,
   —S—S(O)₂—NR—, —NR—O—S(O)—, —NR—O—S(O)—O—, —NR—O—S(O)—NR—,
   —NR—O—S(O)₂—, —NR—O—S(O)₂—O—, —NR—O—S(O)₂—NR—, —O—NR—S(O)—,
   —O—NR—S(O)—O—, —O—NR—S(O)—NR—, —O—NR—S(O)₂—O—,
   —O—NR—S(O)₂—NR—, —O—NR—S(O)₂—, —O—P(O)R₂—, —S—P(O)R₂—, or —NR—P(O)R₂—; where each R is independently hydrogen, alkyl, or substituted alkyl.

In some embodiments, J is substituted or unsubstituted C₆ aryl, oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

In some embodiments, the maleimide-containing resin is represented by

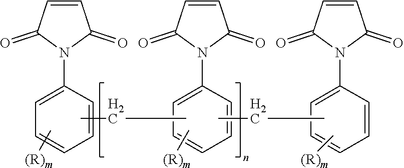

wherein:
each R is independently selected from the group consisting of H and substituted or unsubstituted alkyl;
each m is independently selected from the group consisting of 0, 1, 2, 3, and 4; and
n is 0, 1, 2, 3, 4, and 5.

In some embodiments, the composition comprises a compound represented by

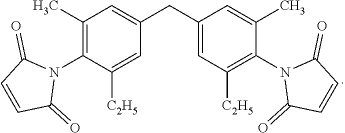 [SMILES: CCc1cc(Cc2cc(C)c(N3C(=O)C=CC3=O)c(CC)c2)cc(C)c1N1C(=O)C=CC1=O]

This compound is referred to in short as BMI-5100 (chemical name: 3,3′-dimethyl-5,5′-diethyl-4,4′-diphenylmethane bismaleimide; Daiwa Kasei, Japan), which is a compound that has an average number molecular weight of around 300 tested by gel permeation chromatography (GPC).

In some embodiments, the maleimide-containing resin is represented by

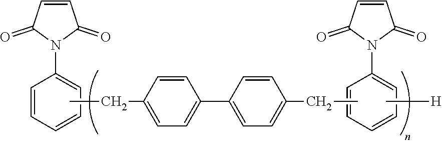

wherein n is 0, 1, 2, 3, 4, or 5.

In some embodiments, the maleimide-containing resin is a BMI resin with a maleimide equivalent weight from 180 to 400. A maleimide equivalent weight is the weight of resin in grams which contains one equivalent of maleimide functional group. In some embodiments, the maleimide-containing resin is a BMI resin with a maleimide equivalent weight of 220. In some embodiments, the maleimide-containing resin is a BMI resin with a maleimide equivalent weight of 300. In some embodiments, the maleimide-containing resin is a BMI resin with a maleimide equivalent weight of about 400. In some embodiments, the maleimide-containing resin is a BMI resin with a maleimide equivalent weight from about 390 to about 400. In some embodiments, the maleimide-containing resin is a BMI resin with a maleimide equivalent weight from 390 to 400.

In some embodiments, maleimide-containing resins are included in amounts ranging from about 1 wt % to about 20 wt %. In some embodiments, maleimide-containing resins are included in amounts ranging from about 1 wt % to about 15 wt %. In some embodiments, maleimide-containing resins are included in amounts ranging from about 3 wt % to about 15 wt %. In some embodiments, maleimide-containing resins are included in amounts ranging from about 1 wt % to about 5 wt %. In some embodiments, maleimide-containing resins are included in amounts ranging from about 5 wt % to about 20 wt %. In some embodiments, maleimide-containing resins are included in amounts ranging from about 5 wt % to about 15 wt %. In some embodiments, maleimide-containing resins are included in amounts ranging from about 10 wt % to about 20 wt %. In some embodiments, maleimide-containing resins are included in amounts ranging from about 10 wt % to about 15 wt %. In some embodiments, maleimide-containing resins are included in amounts ranging from about 12 wt % to about 17 wt %. In some embodiments, maleimide-containing resins are included in about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some embodiments, the itaconimide-containing resin is represented by:

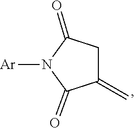

wherein Ar is a substituted or substituted aryl group.

In some embodiments, the itaconimide-containing resin is:

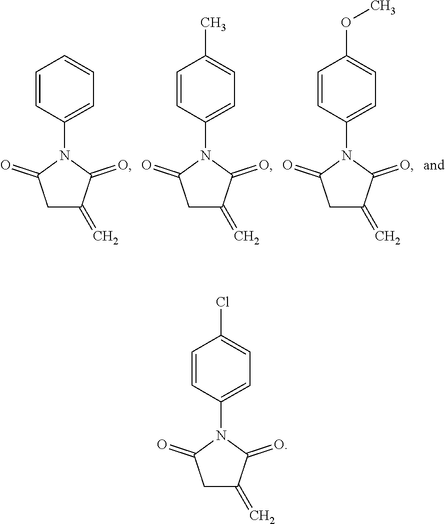

In some embodiments, the nadimide is represented by:

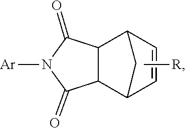

wherein:
Ar is substituted or unsubstituted aryl, and
R is selected from the group consisting of H, substituted or unsubstituted alkyl, substituted or unsubstituted alkenyl, substituted or unsubstituted alkynyl, substituted or unsubstituted aryl, and substituted or unsubstituted heteroaryl.

In some embodiments, desirably the maleimide-containing resins, nadimide-containing resins, or itaconimide-containing resins (a)(i) is selected from the group consisting of:

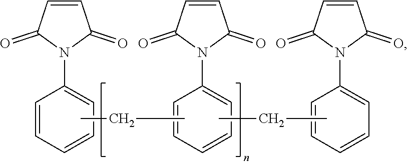

wherein here n is 0˜2,

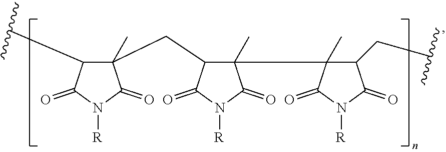

wherein here R is alkyl having 1 to 4 carbon atoms, phenyl, or alkylphenyl having 7 to 11 carbon atoms and n is 1˜12, and

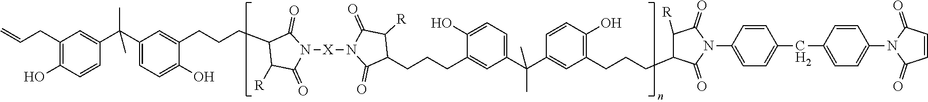

wherein here R is alkyl 1 to 4 having carbon atoms or phenyl, X is diarylalkylene and n is 1˜2.

Compositions of the disclosure, as noted above, include, among other constituents, epoxy resins. A wide variety of epoxy resins are contemplated for use herein, e.g., liquid-type epoxy resins based on bisphenol A, solid-type epoxy resins based on bisphenol A, liquid-type epoxy resins based on bisphenol F (e.g., EPICLON EXA-835LV), multifunctional epoxy resins based on phenol-novolac resin, dicyclopentadiene-type epoxy resins (e.g., EPICLON HP-7200L), naphthalene-type epoxy resins, and the like, as well as mixtures of any two or more thereof.

Exemplary epoxy resins contemplated for use herein include the diepoxide of the cycloaliphatic alcohol, hydrogenated bisphenol A (commercially available as EPALLOY 5000), a difunctional cycloaliphatic glycidyl ester of hexahydrophthallic anhydride (commercially available as EPALLOY 5200), EPICLON EXA-835LV, EPICLON HP-7200L, and the like, as well as mixtures of any two or more thereof.

In certain embodiments, the epoxy resin may include the combination of two or more different bisphenol based epoxies. These bisphenol based epoxies may be selected from bisphenol A, bisphenol F, or bisphenol S epoxies, or combinations thereof. In addition, two or more different bisphenol epoxies within the same type of resin (such A, F or S) may be used.

Commercially available examples of the bisphenol epoxies contemplated for use herein include bisphenol-F type epoxies (such as RE-404-S from Nippon Kayaku, Japan, and EPICLON 830 (RE1801), 830S (RE1815), 830A (REI 826) and 830W from Dai Nippon Ink & Chemicals, Inc., and RSL 1738 and YL-983U from Resolution) and bisphenol-A-type epoxies (such as YL-979 and 980 from Resolution).

The bisphenol epoxies available commercially from Dai Nippon and noted above are promoted as liquid undiluted epichlorohydrin-bisphenol F epoxies having much lower viscosities than conventional epoxies based on bisphenol A epoxies and have physical properties similar to liquid bisphenol A epoxies. Bisphenol F epoxy has lower viscosity than bisphenol A epoxies, all else being the same between the two types of epoxies, which affords a lower viscosity and thus a fast flow underfill sealant material. The EEW of these four bisphenol F epoxies is between 165 and 180. The viscosity at 25° C. is between 3,000 and 4,500 cps (except for RE1801 whose upper viscosity limit is 4,000 cps). The hydrolyzable chloride content is reported as 200 ppm for RE1815 and 830W, and that for RE1826 as 100 ppm.

The bisphenol epoxies available commercially from Resolution and noted above are promoted as low chloride containing liquid epoxies. The bisphenol A epoxies have a EEW (g/eq) of between 180 and 195 and a viscosity at 25° C. of between 100 and 250 cps. The total chloride content for YL-979 is reported as between 500 and 700 ppm, and that for YL-980 as between 100 and 300 ppm. The bisphenol F epoxies have a EEW (g/eq) of between 165 and 180 and a viscosity at 25° C. of between 30 and 60. The total chloride content for RSL-1738 is reported as between 500 and 700 ppm, and that for YL-983U as between 150 and 350 ppm.

In addition to the bisphenol epoxies, other epoxy compounds are contemplated for use as the epoxy resin (a)(ii) of the disclosed compositions. For instance, cycloaliphatic epoxies, such as 3,4-epoxycyclohexylmethyl-3,4-epoxycyclohexylcarbonate, can be used. Also monofunctional, difunctional or multifunctional reactive diluents may be used to adjust the viscosity and/or lower the Tg of the resulting resin material. Exemplary reactive diluents include butyl glycidyl ether, cresyl glycidyl ether, polyethylene glycol glycidyl ether, polypropylene glycol glycidyl ether, and the like.

Still other epoxies suitable for use herein include polyglycidyl derivatives of phenolic compounds, such as those available commercially under the tradename EPON, such as EPON 828, EPON 1001, EPON 1009, and EPON 1031 from Resolution; DER 331, DER 332, DER 334, and DER 542 from Dow Chemical Co.; and BREN-S from Nippon Kayaku. Other suitable epoxies include polyepoxides prepared from polyols and the like and polyglycidyl derivatives of phenol-formaldehyde novolacs, the latter of such as DEN 431, DEN 438, and DEN 439 from Dow Chemical. Cresol analogs are also available commercially under the tradename ARALDITE, such as ARALDITE ECN 1235, ARALDITE ECN 1273, and ARALDITE ECN 1299 from Ciba Specialty Chemicals Corporation. SU-8 is a bisphenol A-type epoxy novolac available from Resolution. Polyglycidyl adducts of amines, aminoalcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE 0500, and ARALDITE 0510 from Ciba Specialty Chemicals and PGA-X and PGA-C from the Sherwin-Williams Co.

Appropriate monofunctional epoxy coreactant diluents for optional use herein also include those that have a viscosity which is lower than that of the epoxy component, ordinarily, less than about 250 cps. The monofunctional epoxy coreactant diluents may have an epoxy group with an alkyl group of about 6 to about 28 carbon atoms, examples of which include C₆₋₂₈ alkyl glycidyl ethers, C₆₋₂₈ fatty acid glycidyl esters, C₆₋₂₈ alkylphenol glycidyl ethers, and the like.

In some embodiments, the epoxy resin is novolac epoxy EEW 200, novolac epoxy EEW 300, or novolac epoxy EEW 140.

In some embodiments, the epoxy resin is a compound represented by

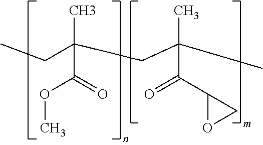

wherein n is 0, 1, 2, 3, 4, or 5, and m is 0, 1, 2, 3, 4, or 5.

In some embodiments, epoxy resins are included in amounts ranging from about 1 wt % to about 30 wt %. In some embodiments, epoxy resins are included in amounts ranging from about 1 wt % to about 25 wt %. In some embodiments, epoxy resins are included in amounts ranging from about 1 wt % to about 20 wt %. In some embodiments, epoxy resins are included in amounts ranging from about 1 wt % to about 15 wt %. In some embodiments, epoxy resins are included in amounts ranging from about 3 wt % to about 15 wt %. In some embodiments, epoxy resins are included in amounts ranging from about 1 wt % to about 5 wt %. In some embodiments, epoxy resins are included in amounts ranging from about 5 wt % to about 20 wt %. In some embodiments, epoxy resins are included in amounts ranging from about 5 wt % to about 15 wt %. In some embodiments, epoxy resins are included in amounts ranging from about 10 wt % to about 20 wt %. In some embodiments, epoxy resins are included in amounts ranging from about 15 wt % to about 30 wt %. In some embodiments, epoxy resins are included in amounts ranging from about 15 wt % to about 25 wt %. In some embodiments, epoxy resins are included in amounts ranging from about 10 wt % to about 15 wt %. In some embodiments, epoxy resins are included in about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, or about 30 wt %.

Desirably, the resins (a) are present in a by weight ratio of (a)(i):(a)(ii) of about 0.3:1 up to about 6:1.

Compositions of the disclosure, as noted above, include, among other constituents' core shell rubbers. Rubber particles having a core-shell structure are an additional component of the compositions of the present invention. Such particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.).

For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also suitably be used for the core, including polybutylacrylate or polysiloxane elastomer (e.g., polydimethylsiloxane, particularly crosslinked polydimethylsiloxane). The rubber particle may be comprised of more than two layers (e.g., a central core of one rubbery material may be surrounded by a second core of a different rubbery material or the rubbery core may be surrounded by two shells of different composition or the rubber particle may have the structure soft core, hard shell, soft shell, hard shell). In one embodiment of the invention, the rubber particles used are comprised of a core and at least two concentric shells having different chemical compositions and/or properties. Either the core or the shell or both the core and the shell may be crosslinked (e.g., ionically or covalently). The shell may be grafted onto the core. The polymer comprising the shell may bear one or more different types of functional groups (e.g., epoxy groups) that are capable of interacting with other components of the compositions of the present invention.

Typically, the core will comprise from 50 to 95 wt % of the rubber particles while the shell will comprise from 5 to 50 wt % of the rubber particles.

The core shell rubber particles are on the nano scale size. That is, the rubber particles have an average diameter of less than 500 nm, such as less than 200 nm, desirably in the range of 25 to 100 nm.

Methods of preparing rubber particles having a core-shell structure are well-known in the art and are described, for example, in U.S. Pat. Nos. 4,419,496, 4,778,851, 5,981,659, 6,111,015, 6,147,142 and 6,180,693.

Rubber particles having a core-shell structure may be prepared as a masterbatch where the rubber particles are dispersed in one or more epoxy resins such as a diglycidyl ether of bisphenol A. For example, the rubber particles typically are prepared as aqueous dispersions or emulsions. Such dispersions or emulsions may be combined with the desired epoxy resin or mixture of epoxy resins and the water and other volatile substances removed by distillation or the like. One method of preparing such masterbatches is described in more detail in International Patent Publication No. WO 2004/108825. For example, an aqueous latex of rubber particles may be brought into contact with an organic medium having partial solubility in water and then with another organic medium having lower partial solubility in water than the first organic medium to separate the water and to provide a dispersion of the rubber particles in the second organic medium. This dispersion may then be mixed with the desired epoxy resin (s) and volatile substances removed by distillation or the like to provide the masterbatch.

Particularly suitable dispersions of rubber particles having a core-shell structure in an epoxy resin matrix are available from Kaneka Corporation, such as KANEKA MX-120 (masterbatch of 25 wt % nano-sized core-shell rubber in a diglycidyl ether of bisphenol A matrix) and KANEKA MX-156.

For instance, the core may be formed predominantly from feed stocks of polybutadiene, polyacrylate, polybutadiene/acrylonitrile mixture, polyols and/or polysiloxanes or any other monomers that give a low glass transition temperature.

The outer shells may be formed predominantly from feed stocks of polymethylmethacrylate, polystyrene or polyvinyl chloride or any other monomers that give a higher glass transition temperature.

The core-shell rubber made in this way may be dispersed in an epoxy matrix or a phenolic matrix. Examples of epoxy matrices include the diglycidyl ethers of bisphenol A, F or S, or biphenol, novolac epoxies, epoxidized nitrogenous based amines, and cycloaliphatic epoxies. Examples of phenolic resins include bisphenol-A based phenoxies.

The core-shell rubber may be dispersed in the epoxy or phenolic matrix in an amount in the range of 5 to 50 wt %, with 15 to 25 wt % being desirable.

At the higher ranges of this core-shell rubber content, viscosity increases may be observed in the dispersion in relatively short periods of time and agglomeration, settling and gelling may also be observed in the dispersions.

In the inventive formulations, use of these core-shell rubbers allows for toughening to occur as the formulation cures, irrespective of the temperatures used to cure the formulation. That is, because of the two phase separation inherent in the formulation due to the core shell rubber—as contrasted for instance with a liquid rubber that is miscible or partially miscible in the formulation and can solidify at temperatures different than those used to cure the formulation—there is a minimum disruption of the matrix properties, as the two phase separation in the formulation is often observed to be substantially uniform in nature.

Many of the core-shell rubbers available commercially from Kaneka are believed to have a core made from a copolymer of (meth)acrylate-butadiene-styrene, where the butadiene is the primary component in the phase separated particles, dispersed in epoxy resins. Other commercially available masterbatches of core-shell rubber particles dispersed in epoxy resins include GENIOPERL M23A (a dispersion of 30 wt % core-shell particles in an aromatic epoxy resin based on bisphenol A diglycidyl ether; the core-shell particles have an average diameter of ca. 100 nm and contain a crosslinked silicone elastomer core onto which an epoxy-functional acrylate copolymer has been grafted); the silicone elastomer core represents about 65 wt % of the core-shell particle), available from Wacker Chemie GmbH, Germany.

A core-shell rubber is included, which itself comprises a polymeric core and at least two polymeric layers surrounding the core, each layer having a different polymer composition from the other layer and, where at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer, and wherein when mixed together the peroxide catalyst initiates cure of the free radical curable component and the transition metal initiates cure of the cyanoacrylate component.

The core-shell rubber should comprise a particle having a particle size between 170 and 350 nm and a pH between 6 and 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition.

The core-shell rubber should comprise a polymeric rubber core surrounded by a polymeric layer which is a polymeric core layer, the polymeric core layer having a glass transition temperature under 0° C. and a different polymer composition than the polymeric rubber core, where the polymeric core layer is a gradient zone. Desirably, the core-shell rubber should comprise at least one polymeric core layer and at least two polymeric shell layers, the polymeric core layer having a different composition than the polymeric shell layers, where each shell layer has a different polymer composition from the other shell layer, and where at least one polymeric shell layer is a gradient zone.

The core-shell rubber should comprise a polymeric rubber core with a glass transition temperature of less than of less than 0° C., such as less than about −10° C., desirably less than about −20° C. and advantageously less than about −25 C and most advantageously less than about −40° C., such as between about −80° C. and about −40° C.

The core-shell rubber should comprise a polymeric rubber core constructed from any one or more of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl (meth)acrylate, or butadiene or isoprene. Desirably, the core should be constructed of one of polybutadiene, a copolymer of butadiene and styrene or a terpolymer of methyl methacrylate, butadiene and styrene.

In some embodiments, the core may also be covered by a core layer. By core layer is meant that the polymer composition of that core layer has a glass transition temperature (Tg) of less than 0° C., such as less than about −10° C., desirably less than about −20° C., and advantageously less than about −25° C. Desirably, the core layer is a gradient polymer.

The core-shell rubber should have more than one shell and desirably two shells. At least the outer shell, in contact with the thermoplastic matrix, has a Tg greater than about 25° C., such as greater than about 50° C.

The shell(s) of the core-shell rubber may be constructed from one or more of: styrene homopolymers, alkylstyrene homopolymers or methyl methacrylate homopolymers, or copolymers comprising at least 70 wt % of one of the above monomers and at least one comonomer chosen from the other above monomers, another alkyl (meth)acrylate, vinyl acetate and acrylonitrile. The shell may be functionalized for instance with anhydrides of unsaturated carboxylic acids, unsaturated carboxylic acids and unsaturated epoxides, for instance maleic anhydride, (meth)acrylic acid glycidyl methacrylate, hydroxyethyl methacrylate and alkyl(meth)acrylamides.

The gradient copolymer is created by occupying a position between two layers, and in so doing creates a gradient zone in which at one side is richer in the monomer/polymer from the neighboring layer and at the other side is richer in the different monomer/polymer that forms the next layer. The gradient zone between the core and a shell or between two polymer shells may be produced for example by monomers that have different copolymerization parameters or by carrying out the reaction in a semi-continuous mode under starved feed conditions where the rate of the addition of the monomers is slower than is the rate of the reaction. The gradient polymer is however never the outermost layer of the core shell particle.

The monomers used to form the gradient polymer are chosen on function of the neighboring layers from the monomers cited with the core and the respective shells.

The young modulus of the polymeric rubber core is always less than the modulus of the other polymeric layers. The young modulus of the layer comprising the gradient polymer is always less than the modulus of the outer most layer.

The core-shell rubber should be in the form of fine particles having a rubber core and at least one thermoplastic shell, the particle size being generally less than 1 μm and advantageously between 50 nm and 500 nm, preferably between 100 nm and 400 nm, and most preferably 150 nm and 350 nm, advantageously between 170 nm and 350 nm.

The core-shell rubber may be prepared by emulsion polymerization. For example, a suitable method is a two-stage polymerization technique in which the core and shell are produced in two sequential emulsion polymerization stages. If there are more shells another emulsion polymerization stage follows. A graft copolymer is obtained by graft-polymerizing a monomer or monomer mixture containing at least an aromatic vinyl, alkyl methacrylate or alkyl acrylate in the presence of a latex containing a butadiene-based rubber polymer. Commercially available examples of such core-shell rubbers ae available commercially under the CLEARSTRENGTH tradename from Arkema Inc., Cary, NC. Arkema describes CLEARSTRENGTH XT100, for instance, as a methyl methacrylate-butadiene-styrene core-shell toughening agent, which is compatible with various monomers and easily dispersible in most liquid resin systems, and exhibits a limited impact on their viscosity while providing a toughening effect over a wide range of service temperatures.

Typically, the core will comprise from about 50 to about 95 wt % of the rubber particles while the shell will comprise from about 5 to about 50 wt % of the rubber particles.

Preferably, the rubber particles are relatively small in size. For example, the average particle size may be from about 0.03 to about 2 microns or from about 0.05 to about 1 micron. The rubber particles may have an average diameter of less than about 500 nm, such as less than about 200 nm. For example, the core-shell rubber particles may have an average diameter within the range of from about 25 to about 200 nm.

These core shell rubbers allow for toughening to occur in the composition and oftentimes in a predictable manner—in terms of temperature neutrality toward cure—because of the substantial uniform dispersion, which is ordinarily observed in the core shell rubbers as they are offered for sale commercially.

The rubber particles may be used in a dry form or may be dispersed in a matrix, as noted above.

Combinations of different rubber particles may advantageously be used in the present invention. The rubber particles may differ, for example, in particle size, the glass transition temperatures of their respective materials, whether, to what extent and by what the materials are functionalized, and whether and how their surfaces are treated.

The core-shell rubber should be present in an amount in the range of about 1 to about 50 wt %, such as about 5 to about 30 wt %, desirably about 10 to about 20 wt %, based on the total weight of the composition.

The core-shell particles (b) should desirably be present in a by weight ratio of (b):(a) about 0.15:1 to about 0.95:1 to the resins (a).

The inventive compositions may also include inorganic fillers, such as silicas.

For instance, when present the inorganic filler may be silica in the form of fumed silica, fused silica, surface activated silica, and any of which being on a nanoscale. The silica nanoparticles can be pre-dispersed in epoxy resins, and may be selected from those commercially available under the tradename NANOPOX, such as NANOPOX XP 0314, XP 0516, XP 0525, from Hanse Chemie, Germany. These NANOPOX-brand products are silica nanoparticle dispersions in epoxy resins, at a level of up to about 50 wt %. These NANOPOX-brand products are believed to have a particle size of about 5 nm to about 80 nm. NANOPOX XP 0314 is reported by the manufacturer to contain 40 wt % of silica particles having a particle size of less than 50 nm diameter in a cycloaliphatic epoxy resin.

In some embodiments, the inorganic filler is an electrically non-conductive filler, such as silicas, as noted above. In some embodiments, the filler is (or comprises) silica, calcium silicate, aluminum hydroxide, magnesium hydroxide, calcium carbonate, magnesium carbonate, aluminum oxide (Al203), zinc oxide (ZnO), magnesium oxide (MgO), aluminum nitride (AlN), boron nitride (BN), carbon nanotubes, diamond, clay, aluminosilicate, and the like, as well as mixtures of any two or more thereof.

In some embodiments, the inorganic filler is an inorganic non-conductive filler comprising particles having a maximum particle size of 5 μm or less than 5 μm. For example, in some embodiments, the filler has a particle size in the from about 0.1 μm to about 5 μm or from 0.1 μm to 5 μm.

In some embodiments, the inorganic fillers are included in an amount ranging from greater than 0 wt %, such as about 10 wt % to about 70 wt %, such as up to about 40 wt %, desirably up to about 25 wt %.

The inorganic fillers (c) should desirably be present in a by weight ratio of (c):(a) about 0.15:1 to about 0.90:1 to the resins (a).

The inorganic fillers (c) should also desirably be present in a by weight ratio of (c):(b) of about 0.95:1 to about 5:1 to the core-shell particles (b).

The composition also includes a curative package. Desirably, the curative package comprises a combination of

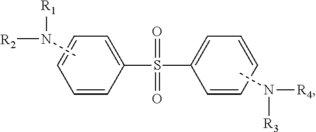

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms,

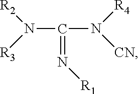

wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and

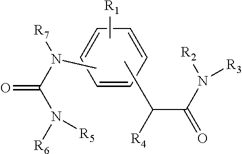

wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms.

Desirably, the curative package (d) comprises an aromatic urea, 4,4-diaminodiphenyl sulfone and dicyandiamide includes

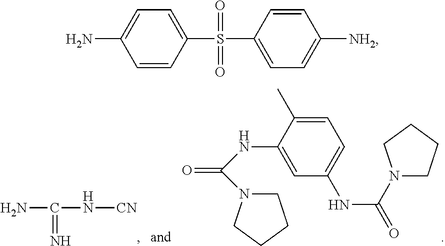

The curative package should be used in the composition in an amount of about 7.0 wt % to about 10 wt %.

The ratio of the three constituents of the curative package may be about. 35 parts:100 parts:10 parts to about 40 parts:135 parts:15 parts.

The curative package (d) should be present in a by weight ratio of (d):(a) of about 0.2:1 to about 0.35:1 to the resins (a).

In some embodiments, after the composition forms a film, the film has certain features and/or properties that make the film suitable for use in thermal compression bonding processes. For example, in some aspects, the composition, after B-staged to a film, demonstrates at least the following physical properties: DSC has an onset temperature of 160° C.˜180° C., DSC has a peak temperature of 180° C.˜210° C., and reaction heat of >30 J/g.

In some aspects, the composition, after B-staged to a film, demonstrates the following physical properties when laminated onto 7 mm×7 mm die, after exposure to a temperature of about 175° C. for a period of time of about 1 hour, the die is measured and shows a warpage of less than about 100 um.

In some aspects, the composition, after B-staged to a film, demonstrates at least the following physical properties when laminated onto a metal lead frame or a BT substrate on a 3 mm×3 mm die, after exposure to a temperature of about 175° C. for a period of time of about 4 hours, the film adheres to the metal lead frame showing adhesion of at least 3 kgf per die.

In some aspects, the composition, after B-staged to a film, demonstrates at least the following physical properties:
DMA (Dynamic Mechanical Analysis), which showed a storage modulus at 25° C. of <2,500 MPa, and
A glass transition temperature Tg of >200° C.

In some aspects, the composition, after B-staged to a film, demonstrates at least the following physical properties:
DMA (Dynamic Mechanical Analysis), which showed a storage modulus at 100° C. of >50 MPa, and
A glass transition temperature Tg of >200° C.

In some aspects, the composition, after B-staged to a film, demonstrates at least the following physical properties:
DMA (Dynamic Mechanical Analysis), which showed a storage modulus at 150° C. of >20 MPa, and
A glass transition temperature Tg of >200° C.

In some aspects, the composition, after B-staged to a film, demonstrates at least the following physical properties:
DMA (Dynamic Mechanical Analysis), which showed a storage modulus at 200° C. of >10 MPa, and
A glass transition temperature Tg of >200° C.

In some aspects, after application to a metal lead frame and curing at a temperature of 260° C. the composition shows die shear strength of >9 kgf/die on copper metal lead frame and >5 kgf/die on silver metal lead frame.

In some embodiments, after the composition forms a cured film, the cured film has a Tg of >100° C., >125° C., >150° C., >160° C., >165° C., >170° C., >175° C., >180° C., >185° C., >190° C., >200° C., >210° C., >220° C., >230° C., >240° C., >250° C., >260° C., >270° C., >280° C., >290° C., or >300° C., each as measured by dynamic mechanical analysis (DMA). In some embodiments, after the composition forms a cured film, the cured film has a Tg of from 100° C. to 110° C., from 110° C. to 120° C., from 120° C. to 130° C., from 130° C. to 140° C., from 140° C. to 150° C., from 150° C. to 160° C., from 160° C. to 170° C., from 170° C. to 180° C., from 180° C. to 190° C., from 190° C. to 200° C., from 200° C. to 210° C., from 210° C. to 220° C., from 220° C. to 230° C., from 230° C. to 240° C., from 240° C. to 250° C., from 250° C. to 260° C., from 260° C. to 270° C., from 270° C. to 280° C., from 280° C. to 290° C., or from 290° C. to 300° C., each as measured by DMA.

In some embodiments, after the composition forms a B-stage film, the B-stage film after cure has a storage modulus at 25° C. of <2,500 MPa, <2,000 MPa, <1,500 MPa, <1000 MPa, <500 MPa, <250 MPa, or <200 MPa.

In some embodiments, after the composition forms a B-stage film, the B-stage film after cure has a storage modulus at 25° C. of from <2,500 MPa, <2,000 MPa to <1,500 MPa, from <1,500 MPa to <1,000 MPa, from <1,000 MPa to <500 MPa, from <500 MPa to <250 MPa, or from <250 MPa to <200 MPa. In some embodiments, after the composition forms a B-stage film, the B-stage film after cure has a storage modulus at 25° C. of from <2,500 MPa to <200 MPa.

In some embodiments, after the composition forms a B-stage film, the B-stage film after cure has a storage modulus at 100° C. of >50 MPa, >100 MPa, >200 MPa, >300 MPa, >400 MPa, >500 MPa, >600 MPa, >700 MPa, >800 MPa, >900 MPa, or >1,000 MPa. In some embodiments, after the composition forms a B-stage film, the B-stage film after cure has a storage modulus at 100° C. of from 50 MPa to 200 MPa, 200 MPa to 300 MPa, from 300 MPa to 400 MPa, from 400 MPa to 500 MPa, from 500 MPa to 600 MPa, from 600 MPa to 700 MPa, from 700 MPa to 800 MPa, from 800 MPa to 900 MPa, or from 900 MPa to 1,000 MPa.

In some embodiments, after the composition forms a B-stage film, the B-stage film after cure has a storage modulus at 150° C. of >20 MPa, >100 MPa, >110 MPa, >120 MPa, >130 MPa, >140 MPa, >150 MPa, >160 MPa, >170 MPa, >180 MPa, >190 MPa, or >200 MPa. In some embodiments, after the composition forms a B-stage film, the B-stage film after cure has a storage modulus at 100° C. of from 20 MPa to 100 MPa, from 100 MPa to 120 MPa, 120 MPa to 130 MPa, from 130 MPa to 140 MPa, from 140 MPa to 150 MPa, from 150 MPa to 160 MPa, from 160 MPa to 170 MPa, from 170 MPa to 180 MPa, from 180 MPa to 190 MPa, or from 190 MPa to 200 MPa.

In some embodiments, after the composition forms a B-stage film, the B-stage film after cure has a storage modulus at 200° C. of >10 MPa, >45 MPa, >50 MPa, >55 MPa, or >60 MPa, >65 MPa, >70 MPa, >75 MPa, >80 MPa, >85 MPa, >90 MPa, >95 MPa, or >100 MPa. In some embodiments, after the composition forms a B-stage film, the B-stage film after cure has a storage modulus at 200° C. of from 10 MPa to 50 MPa, 50 MPa to 55 MPa, from 55 MPa to 60 MPa, from 60 MPa to 65 MPa, from 65 MPa to 70 MPa, from 70 MPa to 75 MPa, from 75 MPa to 80 MPa, from 80 MPa to 85 MPa, from 85 MPa to 90 MPa, from 90 MPa to 95 MPa, or from 95 MPa to 100 MPa.

In some embodiments, after the composition forms a B-stage film, the B-stage film has a minimum film melt viscosity from 10 Pa·s to 2,000 Pa·s as measured using a DHR2 rheometer with a 10° C./min ramping rate in N₂. In some embodiments, after the composition forms a B-stage film, the B-stage film has a minimum film melt viscosity from 20 Pa·s to 1,800 Pa·s as measured using a DHR2 rheometer with a 10° C./min ramping rate in N₂. In some embodiments, after the composition forms a B-stage film, the B-stage film has a minimum film melt viscosity from 30 Pa s to 1,500 Pa·s as measured using a DHR2 rheometer with a 10° C./min ramping rate in N₂. In some embodiments, after the composition forms a B-stage film, the B-stage film has a minimum film melt viscosity from 50 Pa·s to 1,200 Pa·s as measured using a DHR2 rheometer with a 10° C./min ramping rate in N₂. In some embodiments, after the composition forms a B-stage film, the B-stage film has a minimum film melt viscosity from 100 Pa·s to 1,000 Pa·s as measured using a DHR2 rheometer with a 10° C./min ramping rate in N₂.

In some embodiments, after the composition forms a B-stage film, the B-stage film has a differential scanning calorimetry (“DSC”) onset temperature of from 160° C. to 170° C., from 170° C. to 180° C., as measured by DSC with a 10° C./min ramping rate in N₂.

In some embodiments, after the composition forms a B-stage film, the B-stage film has a DSC onset temperature of from about 160° C. to about 170° C., from about 170° C. to about 180° C., from about 180° C. to about 190° C., from about 190° C. to about 200° C., from about 200° C. to about 210° C., as measured by DSC with a 10° C./min ramping rate in N₂.

The present disclosure refers to certain organic groups as being, in some embodiments, “substituted.” The term “substituted” means that the subject organic group bears one or more substituents, where a substituent is an atom or a group of atoms that replaces a hydrogen atom on the subject organic group. Where an organic group is substituted, a substituent may replace one or more hydrogen atoms, ranging from replacement of exactly one hydrogen atom to the replacement of all hydrogen atoms on the subject organic group. Where an organic group may bear multiple substituents, the substituents are selected independently and can be, but need not be, identical.

The present disclosure refers to certain organic groups as being, in some embodiments, “unsubstituted.” The term “unsubstituted” means that the subject organic group bears no substituents (as that term is described above).

The inventive compositions may also include coreactants, curatives and/or catalysts. Examples include Lewis acids, such as phenols and derivatives thereof, strong acids, such as alkylenic acids and cationic catalysts.

The inventive compositions also include adhesion promoters and film formers.

As used herein, the term “adhesion promoters” refers to compounds that enhance the adhesive properties of the formulation to which they are introduced. Adhesion promoters can be organic or inorganic compounds and can include combinations thereof. Non-limiting examples of adhesion promoters include organo-zirconate compounds, organo-titanate compounds, and silane coupling agents. In some embodiments, the adhesion promoter is Z6040 from Dow Corporation, Midland, MI.

In some embodiments, adhesion promoters are included in an amount ranging from about 0.1 wt % to about 5 wt %. In some embodiments, adhesion promoters are included in an amount ranging from about 0.1 wt % to about 1.0 wt %. In some embodiments, adhesion promoters are included in an amount ranging from about 0.5 wt % to about 1.0 wt %. In some embodiments, adhesion promoters are included in an amount ranging from about 0.5 wt % to about 1.5 wt %. In some embodiments adhesion promoters are included in an amount ranging from about 1 wt % to about 2 wt %, about 2 wt % to about 3 wt %, about 3 wt % to about 4 wt %, or about 4 wt % to about 5 wt %.

As used herein, the term “film formers” refers to compounds that assist in the formation of a film, such as by increasing the viscosity of the combined materials. Non-limiting examples of film formers including elastomeric additive components such as, but not limited to, copolymeric ethylene acrylic elastomers, natural or synthetic rubbers such as substituted polyethylenes, resins such as polyvinyl butyral resins and chlorosulfonated polyethylene synthetic rubbers (CSM), partially cross-linked butyl rubber compounds such as butyl rubber products commercially available from Royal Elastomers, New Jersey under the brand names KALAR, DPR, ISOLENE and KALENE, and ethylene acrylic elastomeric materials such as VAMAC, which is commercially available from DuPont Corporation. Additional non-limiting examples of film formers include, but are not limited to, acrylic polymers such as copolymers of butyl acrylate-ethyl acrylate-acetonitrile and copolymers of ethyl acrylate-acetonitrile (e.g., polymers comprising glycidyl functional groups), commercially available examples of which include those from Nagase JP.

In some embodiments, film former (or, binder resins) are included in amounts ranging from about 1 wt % to about 25 wt %. In some embodiments, binder resins are included in amounts ranging from about 1 wt % to about 20 wt %. In some embodiments, binder resins are included in amounts ranging from about 10 wt % to about 20 wt %. In some embodiments, binder resins are included in amounts ranging from about 13 wt % to about 18 wt %. In some embodiments, binder resins are included in amounts ranging from about 14 wt % to about 16 wt %. In some embodiments, binder resins are included in amounts of about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt %.

Aspects of the disclosure also relate to methods of preparing B-stage films and/or cured films.

In some embodiments, the methods of preparing cured films comprise:
providing a composition comprising
   two or more resins selected from the group consisting of (i) maleimide-containing resins, nadimide-containing resins, itaconimide-containing resins, and (ii) epoxy resins,
   core shell particles,
   optionally, inorganic fillers;
   a curative package
casting the composition into a film; and
exposing the cast film to elevated temperature to cure the film.

In some embodiments of the methods of preparing cured films, the two or more resins selected from the group consisting of maleimide-containing resins, nadimide-containing resins, itaconimide-containing resins, and epoxy resins, are those disclosed elsewhere herein and, optionally, in the amounts disclosed elsewhere herein.

In some embodiments of the methods of preparing cured films, the core shell rubbers are those disclosed elsewhere herein and, optionally, are present in the amounts disclosed elsewhere herein.

In some embodiments of the methods of preparing cured films, the inorganic fillers are those disclosed elsewhere herein and, optionally, when present are in the amounts disclosed elsewhere herein.

In some embodiments of the methods of preparing cured films, the one or more additives selected from adhesion promoters and film formers are those disclosed elsewhere herein and, optionally, are present in the amounts disclosed elsewhere herein.

### EXAMPLES

### Example 1

### Sample Preparation

Screening formulations to identify the curing agent package according to the invention were prepared by combining the components set forth in Table 1 below. As can be seen the only variables in the components are the catalysts.

TABLE 1

| | Sample Nos./Amt (wt %) | | | | | | |
|---|---|---|---|---|---|---|---|
| | Screening | Screening | Screening | Screening | Screening | Screening | Screening |
| Ingredients | sample 1 | sample 2 | sample 3 | sample 4 | sample 5 | sample 6 | sample 7 |
| Silica fillers | 4.88 | 4.88 | 4.88 | 4.88 | 4.88 | 4.88 | 4.88 |
| Epoxy | 7.20 | 7.20 | 7.20 | 7.20 | 7.20 | 7.20 | 7.20 |
| resins | | | | | | | |
| BMI resins | 16.70 | 16.70 | 16.70 | 16.70 | 16.70 | 16.70 | 16.70 |
| CSR (core- | 12.50 | 12.50 | 12.50 | 12.50 | 12.50 | 12.50 | 12.50 |
| shell | | | | | | | |
| rubber) MX- | | | | | | | |
| 154 | | | | | | | |
| Adhesion | 0.8 | 0.8 | 0.8 | 0.8 | 0.8 | 0.8 | 0.8 |
| promoter, | | | | | | | |
| Silane | | | | | | | |
| Z6040 | | | | | | | |
| Catalyst1 | 5.1 | 0 | 0 | 5.1 | 5.1 | 0 | 5.1 |
| Catalyst2 | 0 | 0 | 1.7 | 0 | 1.7 | 1.7 | 1.7 |
| Catalyst3 | 0.00 | 0.50 | 0.00 | 0.50 | 0.00 | 0.50 | 0.50 |
| Binder | 50.62 | 50.62 | 50.62 | 50.62 | 50.62 | 50.62 | 50.62 |
| rubber resin | | | | | | | |

Catalyst1 is 4,4-DDS (4,4-Diaminodiphenyl sulfone); Catalyst2 is Urea type of curing accelerator; Catalyst3 is DICY (Dicyandiamide).

### Varnish Preparation

Silica filler slurry in suitable solvent was cavitated for dispersion purpose. The required amounts of the organic components were weighed into the filler slurry container, hand mixed for about 5 minutes, then sufficient additional solvents were added to for a solid content of 40˜50% and viscosity 100˜400 cps. Pre-mixing continued for about 5-10 minutes with a high speed mixer (about 1000-3000 rpm). The resulting varnish was filtered by 10 um filter to remove any oversized coarse resin or filler particles.

### Film Preparation

Film sheet samples were prepared by pouring the slurry onto a clean, prepared Surface using a coating machine. The slurry was subsequently heated in a retort oven to produce a stable coating film that is well bonded to the substrate (the release liner). A cover liner is then applied onto the film to protect the surface thereof under the desirable film lamination heat and pressure.

### DSC

For DSC analysis, a 10 mg film sample was subjected to 10° C./min temp ramp from room temperature to 350° C., in N₂ atmosphere, to collect data of DSC onset temperature, peak temperature, and reaction heat.

### DMA

DMA analysis of tensile modulus was performed on film samples employing a TA Instruments, TA-Q800 using a flat edge tension film fixture on the TA-Q800. Sample dimensions were approximately (20×8×0.3 mm). Samples were cured by subjecting them to a 30 min ramp from room temperature to 175° C., then soaked for 1 hour at 175° C.

DMA was carried out at a ramp rate of 5.0° C./min starting at −70° C. up to 300° C. The frequency was 10 Hz and 5 microns was applied for strain amplitude.

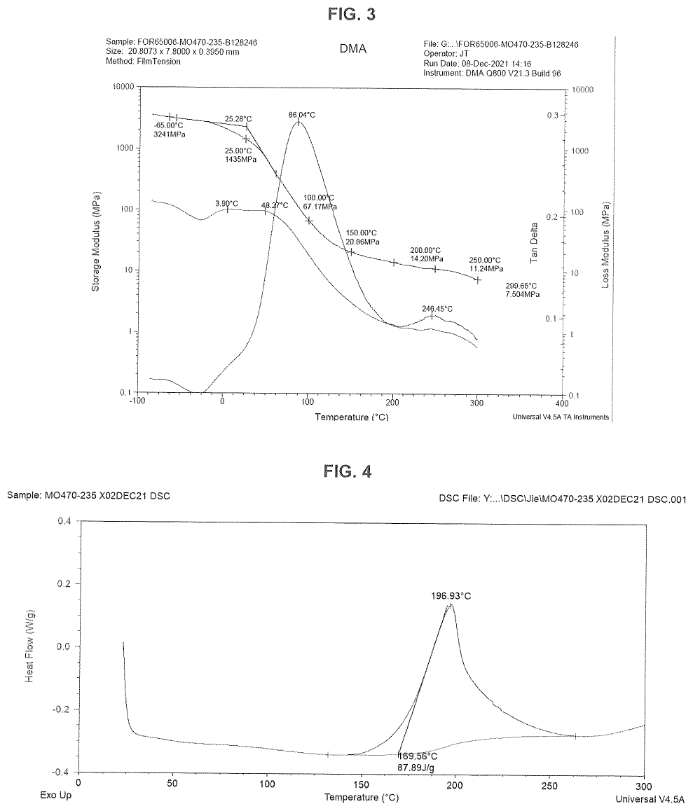

Reference to FIG. 3 shows a DMA graph where the cured film had low room temperature modulus for low warpage, and high modulus at a high temperature—such as 200° C.—for meeting wirebonding process requirement for small die applications. And the DMA graph also shows an additional tan δ (T_{g}, glass transition temperature) at a high temperature—246.45° C.—, indicating the curing of bismaleimide resins into the epoxy network to enhance the high temperature properties of the cured composition.

### Die Shear Strength

Film sample was laminated onto silicon dies (3×3 mm) and then placed onto substrate [Cu lead frame substrate, Ag lead frame substrate, Au-plated Cu (PPF) lead frame substrate, and BT substrate] by a die bonder at 120° C. with 1 kg force for 5 seconds. Parts were subjected to curing by a 30 min ramp from room temperature to 175° C., then soaked for 4 hours at 175° C. HDSS (hot die shear strength) data was tested shearing the die at 260° C. HWDSS (hot wet die shear strength) data was tested shearing the die at 260° C. at 85° C./85% RH after 24 hours. HWDSS was repeated three times.

The B-staged film was evaluated for melt viscosity using a TA instrument, DHR2 rheometer, with a 5° C./min ramping rate in N₂. Sample dimensions were approximately 550 μm thick and 20 mm in diameter. Each formulation from Table 1 was subjected to a number of analyses, as noted in the leftmost column. Results were summarized and presented in Table 2 below.

TABLE 2

| | Sample Nos. | | | | | | |
|---|---|---|---|---|---|---|---|
| Physical | Screening | Screening | Screening | Screening | Screening | Screening | Screening |
| Properties | sample 1 | sample 2 | sample 3 | sample 4 | sample 5 | sample 6 | sample 7 |
| DSC Tₒₙₛₑₜ (° C.) | 160.97 | 180.23 | 157.03 | 173.66 | 156.72 | 179.19 | 175.23 |
| DSC Tₚₑₐₖ (° C.) | 167.11 | 214.80 | 165.38, 207.53 | 215.05 | 166.95, 198.51 | 205.58 | 201.52 |
| DSC reaction | 3.952 | 16.57 | 75.01 | 37.72 | 91.03 | 68.51 | 88.00 |
| heat (J/g) | | | | | | | |
| Melt viscosity | 121 | 141 | 124 | 111 | 115 | 117 | 94 |
| at 120° C. (Pas) | | | | | | | |
| DMA storage | 3,962 | 3,374 | 3,299 | 3,488 | 3,651 | 3,863 | 3,947 |
| modulus - −65° | | | | | | | |
| C. (MPa) | | | | | | | |
| DMA storage | 1,364 | 1,166 | 1,337 | 1,525 | 1,534 | 1,405 | 2,033 |
| modulus -- | | | | | | | |
| 25° C. (MPa) | | | | | | | |
| DMA storage | 1.2 | 1.6 | 75.4 | 5.0 | 82.4 | 52.9 | 505 |
| modulus -- | | | | | | | |
| 100° C. (MPa) | | | | | | | |
| DMA storage | — | — | 20.5 | 0.5 | 17.7 | 15.5 | 90.7 |
| modulus -- | | | | | | | |
| 150° C. (MPa) | | | | | | | |
| DMA storage | — | — | 10.6 | — | 10.7 | 11.2 | 47 |
| modulus -- | | | | | | | |
| 200° C. (MPa) | | | | | | | |
| Tg (by tan delta | 61.5, 127 | 56.4 | 87 | 66, 132.5 | 92 | 79.5 | 66.5, |
| in DMA) (° C.) | | | | | | | 33, 214 |
| HDSS at | 5.79 | 3.25 | 4.52 | 11.12 | 4.35 | 12.47 | 13.05 |
| 260° C. on Cu | | | | | | | |
| substrate | | | | | | | |
| (kgf/die) | | | | | | | |
| HDSS at | 3.22 | 4.75 | 5.94 | 7.71 | 5.76 | 11.67 | 11.80 |
| 260° C. on Ag | | | | | | | |
| substrate | | | | | | | |
| (kgf/die) | | | | | | | |
| HDSS at | 2.56 | 3.93 | 8.18 | 9.08 | 7.40 | 9.37 | 11.92 |
| 260° C. on PPF | | | | | | | |
| substrate | | | | | | | |
| (kgf/die) | | | | | | | |
| HDSS at | 5.42 | 3.01 | 11.26 | 5.20 | 14.40 | 10.92 | 12.94 |
| 260° C. on BT | | | | | | | |
| substrate | | | | | | | |
| (kgf/die) | | | | | | | |

Reference to Table 2 shows screening sample 7 with an epoxy/bismaleimide (“BMI”) resin combination using the three-part curing agent package showed higher adhesion to both metal lead frame and BT substrates than the other samples screened. Screening sample 7 also showed a cured film having low room temperature modulus for low warpage, and high modulus of 47 MPa at high temperature of 200° C. This combination of physical properties is particularly attractive for wirebonding process requirement for small die applications. And the DMA data also showed a high tan δ (Tg, glass transition temperature) temperature >200° C., indicating the presence of enhanced high temperature properties.

### Example 2

Formulations according to the invention were prepared by combining the components set forth in Table 3 below.

TABLE 3

| | Sample Nos./Amt (wt %) | | | | | |
|---|---|---|---|---|---|---|
| | Inven- | Inven- | Inven- | Inven- | Inven- | Inven- |
| | tive | tive | tive | tive | tive | tive |
| | sam- | sam- | sam- | sam- | sam- | sam- |
| Ingredients | ple 1 | ple 2 | ple 3 | ple 4 | ple 5 | ple 6 |
| Silica filler1 | 25 | 25 | 4.88 | 4.88 | | |
| Silica filler2 | | | | 2 | | |
| Epoxy resin1 | 16.7 | 8.45 | 7.2 | 7.2 | | |
| BMI 1 | 7.2 | 8.3 | 16.7 | 14.7 | 12.5 | 12.5 |
| BMI 2 | | | | | 12.5 | |
| BMI 3 | | | | | | 12.5 |
| CSR1 | 12.5 | 18.75 | 12.5 | 12.5 | 7.5 | 7.5 |
| CSR2 | | | | | 25 | 25 |
| Adhesion | 0.8 | 0.8 | 0.8 | 0.8 | 0.8 | 0.8 |
| promoter | | | | | | |
| Silane Z6040 | | | | | | |
| Catalyst1 | 5.1 | 5.1 | 5.1 | 5.1 | 6.63 | 6.63 |
| Catalyst2 | 1.7 | 1.7 | 1.7 | 1.7 | 2.21 | 2.21 |
| Catalyst3 | 0.5 | 0.5 | 0.5 | 0.5 | 0.65 | 0.65 |
| Binder rubber | 30.5 | 31.4 | 50.62 | 50.62 | 32.21 | 32.21 |
| resin | | | | | | |

Silica filler1 is micron size silica fillers, with particle size of average <0.5 um;
Silica filler 2 is fumed silica
Epoxy resin 1 is Cycloaliphatic epoxy resin from Daicel
BMI 1 is phenylmethane maleimide oligomer; BMI 2 is HOMIDE 802 BMI resin; BMI 3 is HOMIDE 400 BMI resin. BMI 2 and BMI 3 are from Hos-Tec.
CSR1 is PBd core shell rubber, in liquid BisA epoxy resin (40 wt %);
CSR2 is Styrene-PBd copolymer core shell rubber
Catalyst1 is 4.4-DDS (4,4-Diaminodiphenyl sulfone); Catalyst2 is Urea type of curing accelerator.
Catalyst3 is DICY (Dicyandiamide).

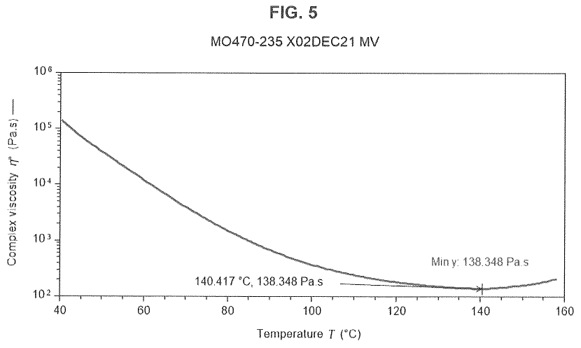

Each of the inventive samples in Table 3 was subjected to a number of analyses. Results were summarized and presented in Table 4 below. See also FIG. 3 for graphical representation of DMA; FIG. 4 for graphical representation of DSC; and FIG. 5 for graphical representation of melt viscosity. The melt viscosity, which is low is beneficial for a film to have good wetting properties to a substrate in BGA packaged during the die attach step.

TABLE 4

| | Sample Nos. | | | | | |
|---|---|---|---|---|---|---|
| Physical | Inventive | Inventive | Inventive | Inventive | Inventive | Inventive |
| Properties | sample 1 | sample 2 | sample 3 | sample 4 | sample 5 | sample 6 |
| DSC onset | 171 | 171 | 178 | 178 | 163 | 165 |
| temperature (° C.) | | | | | | |
| DSC peak | 194 | 194 | 203 | 201 | 198 | 188 |
| temperature (° C.) | | | | | | |
| DSC reaction | 86 | 85 | 95 | 83 | 89 | 104 |
| heat (J/g) | | | | | | |
| Melt viscosity at | 674 | 973 | 80 | 163 | 1,404 | 1,357 |
| 120° C. (Pas) | | | | | | |
| DMA storage | 4,560 | 4,213 | 3,087 | 3,350 | 3,159 | 3,087 |
| modulus | | | | | | |
| at −65° C. (MPa) | | | | | | |
| DMA storage | 2,384 | 2,211 | 1,290 | 1,539 | 1,184 | 1,210 |
| modulus at 25° C. | | | | | | |
| (MPa) | | | | | | |
| DMA storage | 255 | 256 | 64 | 148 | 333 | 383 |
| modulus at | | | | | | |
| 100° C. (MPa) | | | | | | |
| DMA storage | 104 | 113 | 18 | 44 | 178 | 249 |
| modulus at | | | | | | |
| 150° C. (MPa) | | | | | | |
| DMA storage | 59 | 71 | 12 | 28 | 75 | 129 |
| modulus at | | | | | | |
| 200° C. (MPa) | | | | | | |
| Tg (by tan delta | 86,254 | 88,260 | 88,285 | 101,273 | 55,273 | 74,279 |
| in DMA) (° C.) | | | | | | |

The results showed the cured film material had low room temperature modulus for low warpage (<2,500 MPa at 25° C.). And the DMA data also showed a high tan δ (Tg, glass transition temperature) temperature >200° C., indicating the presence of enhanced high temperature properties. Reference may also be made to FIGS. 3 and 4, for a graphical representation. There, it may be seen that the film material had a DSC onset temperature in the range of 160° C.˜180° C., a DSC peak temperature of 180° C.˜210′° C., and reaction heat of >30 J/g.

The adhesion strength of each of the six inventive samples of Table 3 was also tested on 4 different substrates. Commercial DDF1 is ATB100 and DDF2 is ATBF100E, each available from Henkel Corporation.

The adhesion data was tested at the same time as the inventive samples under the same conditions to remove any artificial variations caused by different test conditions. Results of hot die shear strength and hot wet die shear strength evaluations were summarized and presented in Table 5 below.

TABLE 5

| | Sample Nos. | | | | | | | |
|---|---|---|---|---|---|---|---|---|
| Physical | Commercial | Commercial | Inventive | Inventive | Inventive | Inventive | Inventive | Inventive |
| Properties | DDF 1 | DDF 2 | sample 1 | sample 2 | sample 3 | sample 4 | sample 5 | sample 6 |
| HDSS at | 2.5 | 1.5 | 10.0 | 11.0 | 16.6 | 11.8 | 10.2 | 9.4 |
| 260° C. on Cu | | | | | | | | |
| substrate | | | | | | | | |
| (kgf/die) | | | | | | | | |
| HDSS at | 3.2 | 3.0 | 5.8 | 9.4 | 9.3 | 7.9 | 6.8 | 7.1 |
| 260° C. on Ag | | | | | | | | |
| substrate | | | | | | | | |
| (kgf/die) | | | | | | | | |
| HDSS at | 1.3 | 1.7 | 6.7 | 11.7 | 13.1 | 10.0 | 9.7 | 5.0 |
| 260° C. on | | | | | | | | |
| PPF | | | | | | | | |
| substrate | | | | | | | | |
| (kgf/die) | | | | | | | | |
| HDSS at | 4.4 | 9.0 | 5.5 | 5.2 | 9.4 | 9.3 | 7.9 | 4.1 |
| 260° C. on BT | | | | | | | | |
| substrate | | | | | | | | |
| (kgf/die) | | | | | | | | |
| HWDSS at | 1.8 | 0.7 | 7.6 | 11.1 | 11.6 | 9.0 | 6.6 | 6.6 |
| 260° C. on Cu | | | | | | | | |
| substrate | | | | | | | | |
| (kgf/die) | | | | | | | | |
| HWDSS at | 2.0 | 0.8 | 6.5 | 4.5 | 7.3 | 8.3 | 5.2 | 3.5 |
| 260° C. on Ag | | | | | | | | |
| substrate | | | | | | | | |
| (kgf/die) | | | | | | | | |
| HWDSS | 1.6 | 0.6 | 7.5 | 10.7 | 6.6 | 8.6 | 2.8 | 3.8 |
| at 260° C. | | | | | | | | |
| on PPF | | | | | | | | |
| substrate | | | | | | | | |
| (kgf/die) | | | | | | | | |
| HWDSS at | 5.8 | 7.6 | 6.3 | 5.7 | 8.0 | 5.9 | 5.6 | 5.7 |
| 260° C. on BT | | | | | | | | |
| substrate | | | | | | | | |
| (kgf/die) | | | | | | | | |

The results show these samples have higher adhesion, both after cure under hot conditions and under hot and moist conditions, to multiple metal lead frames as well as BT substrate than existing Henkel commercial die attach films.

1. A composition comprising:
(a) two or more resins selected from the group consisting of: (i) at least one of maleimide-containing resins, nadimide-containing resins, or itaconimide-containing resins, and (ii) epoxy resins;
(b) core shell particles, wherein said core shell particles comprise a polymeric material having elastomeric or rubbery properties surrounded by a shell comprised of a non-elastomeric polymeric material;
(c) optionally, inorganic fillers;
(d) a curative package comprising 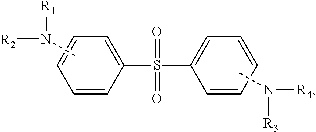
wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, 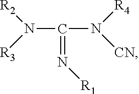
wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and 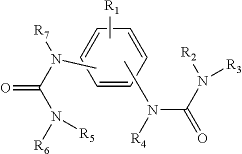
wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms; and
(e) one or more additives selected from the group consisting of adhesion promoters and film formers.

2. The composition of claim 1, wherein after the composition forms a B-staged film, the B-staged film has the following physical properties:
DSC has an onset temperature of 160° C.˜180° C.,
DSC has a peak temperature of 180° C.˜210° C., and
reaction heat of >30 J/g.

3. The composition of claim 1, wherein after the composition forms a B-staged film, the B-staged film when laminated onto 7 mm×7 mm die, after exposure to a temperature of about 175° C. for a period of time of about 1 hour, the die is measured and shows a warpage of less than about 100 um.

4. The composition of claim 1, wherein after the composition forms a B-staged film, the B-staged film when laminated onto a metal lead frame or a BT substrate on a 3 mm×3 mm die, after exposure to a temperature of about 175° C. for a period of time of about 4 hours, the film adheres to the metal lead frame showing adhesion of at least 3 kgf per die.

5. The composition of claim 1, wherein after the composition forms a B-staged film, the B-staged film shows the following properties:
DMA (Dynamic Mechanical Analysis), which showed a storage modulus at 25° C. of <2,500 MPa, and
A glass transition temperature Tg of >200° C.

6. The composition of claim 1, wherein after the composition forms a B-staged film, the B-staged film shows the following properties:
DMA (Dynamic Mechanical Analysis), which showed a storage modulus at 100° C. of >50 MPa, and
A glass transition temperature Tg of >200° C.

7. The composition of claim 1, wherein after the composition forms a B-staged film, the B-staged film shows the following properties:
DMA (Dynamic Mechanical Analysis), which showed a storage modulus at 150° C. of >20 MPa, and
A glass transition temperature Tg of >200° C.

8. The composition of claim 1, wherein after the composition forms a B-staged film, the B-staged film shows the following properties:
DMA (Dynamic Mechanical Analysis), which showed a storage modulus at 200° C. of >10 MPa, and
A glass transition temperature Tg of >200° C.

9. The composition of claim 1, wherein after application to a metal lead frame and curing at a temperature of 260° C. the composition shows die shear strength of >9 kgf/die on copper metal lead frame and >5 kgf/die on silver metal lead frame.

10. The composition of claim 1, wherein the maleimide-containing resins, nadimide-containing resins, or itaconimide-containing resins (a)(i) are present in an amount from about 5 wt % to about 25 wt %.

11. The composition of claim 1, wherein the epoxy resins (a)(ii) are present in an amount from about 1 wt % to about 30 wt %.

12. The composition of claim 1, wherein the resins (a) are present in a by weight ratio of (a)(i):(a)(ii) of about 0.3:1 up to about 6:1.

13. The composition of claim 1, wherein the core shell particles (b) are present in an amount of about 5 wt % to about 30 wt %.

14. The composition of claim 1, wherein the core shell particles (b) are present in a by weight ratio of (b):(a) about 0.15:1 to about 0.95:1 to the resins (a).

15. The composition of claim 1, wherein the inorganic fillers (c) are present in an amount greater than 0 wt % to about 40 wt %.

16. The composition of claim 1, wherein the inorganic fillers (c) are present in an amount greater than 0 wt % to about 25 wt %.

17. The composition of claim 1, wherein the inorganic fillers (c) are present in a by weight ratio of (c):(a) about 0.15:1 to about 0.90:1 to the resins (a).

18. The composition of claim 1, wherein the inorganic fillers (c) are present in a by weight ratio of (c):(b) of about 0.95:1 to about 5:1 to the core-shell particles (b).

19. The composition of claim 1, wherein the curative package (d) comprises an aromatic urea, 4,4-diaminodiphenyl sulfone and dicyandiamide.

20. The composition of claim 1, wherein the curative package (d) comprises an aromatic urea, 4,4-diaminodiphenyl sulfone and dicyandiamide in a by weight ratio of about. 35 parts:100 parts:10 parts to about 40 parts:135 parts:15 parts

21. The composition of claim 1, wherein the curative package (d) is present in a by weight ratio of (d):(a) of about 0.2:1 to about 0.35:1 to the resins (a).

22. The composition of claim 1, wherein the curative package (d) comprises

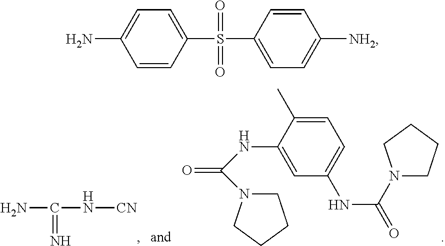

23. The composition of claim 1, wherein the maleimide-containing resins, nadimide-containing resins, or itaconimide-containing resins (a)(i) is selected from the group consisting of: 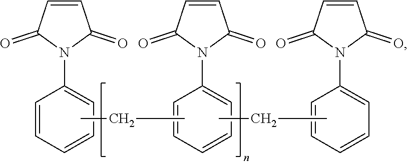
wherein here n is 0˜2, 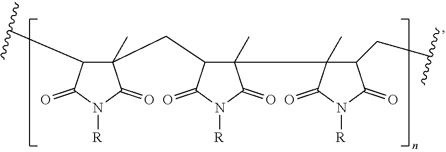
wherein here R is alkyl having 1 to 4 carbon atoms, phenyl, or alkylphenyl having 7 to 11 carbon atoms and n here is 1˜12, 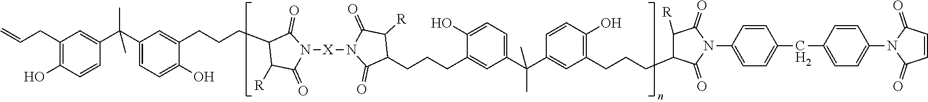
wherein here R is alkyl 1 to 4 having carbon atoms or phenyl, X is diarylalkylene and n is 1˜2, 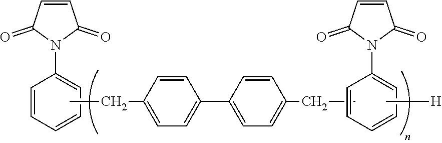
wherein n is 0, 1, 2, 3, 4, or 5, or

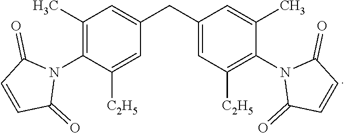 [SMILES: CCc1cc(Cc2cc(C)c(N3C(=O)C=CC3=O)c(CC)c2)cc(C)c1N1C(=O)C=CC1=O]

24. The composition of claim 1, wherein the epoxy resins (a)(ii) is selected from the group consisting of: 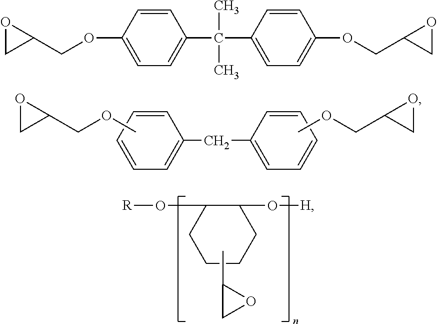
wherein here R is alkyl having 1 to 4 carbon atoms and n here is 1˜16, and 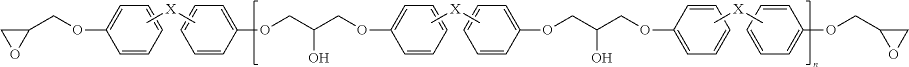
wherein here X is alkylene having 1 to 4 carbon atoms and n here is 0˜75.

25. A curative package comprising 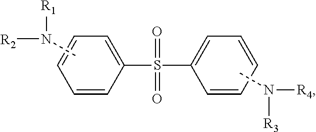
wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, 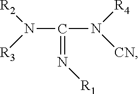
wherein here R₁, R₂, R₃ and R₄ are each independently selected from H, alkyl having 1 to 4 carbon atoms, alkoxy having 2 to 5 carbon atoms and hydroxy alkyl having 1 to 4 carbon atoms, and 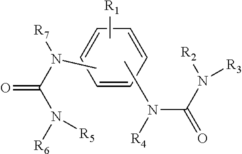
wherein here R₁, R₂, R₃, R₄, R₅, and R₆ wherein here R₁, R₂, R₃, R₄, R₅, and R₆ are each independently selected from H, alkyl having 1 to 4 carbon atoms, alkoxy having 2 to 5 carbon atoms and hydroxy alkyl having 1 to 4 carbon atoms, and each of R₂ and R₃ and R₅ and R₆ taken together make up independently of one another a cyclic ring of 3 to 7 atoms.

26. A curative package comprising 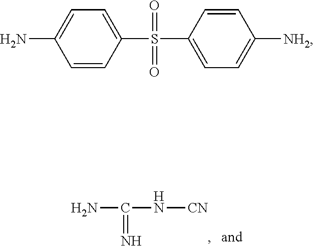 [SMILES: Nc1ccc(S(=O)(=O)c2ccc(N)cc2)cc1 ; N#CNC(=N)N]
